(19) United States
(12) Patent Application Publication
(10) Pub. No.: US 2025/0304262 A1
(43) Pub. Date: Oct. 2, 2025

(54) BLEEDLESS ENVIRONMENTAL CONTROL SYSTEM WITH MOTORIZED AIR CYCLE MACHINE

(71) Applicant: Hamilton Sundstrand Corporation, Charlotte, NC (US)

(72) Inventors: Louis J. Bruno, Ellington, CT (US); Kayla Gosse, Ellington, CT (US); Aiden Coutin, Ogden, UT (US)

(21) Appl. No.: 19/018,485

(22) Filed: Jan. 13, 2025

Related U.S. Application Data
(60) Provisional application No. 63/573,059, filed on Apr. 2, 2024.

(51) Int. Cl. B64D 13/02; B64D 13/06; B64D 13/08

(52) U.S. Cl. CPC B64D 13/02; B64D 13/08; B64D 2013/0644; B64D 2013/0648

(57) ABSTRACT

An environmental control system of a vehicle includes a first inlet for receiving a first medium, a second inlet for receiving a second medium, and at least one thermodynamic device fluidly coupled to the first inlet and the second inlet. The at least one thermodynamic device includes a compressor, at least one turbine, and an electric motor, operably coupled by a shaft. The second inlet is fluidly connected to the electric motor such that a flow of the second medium is operable as a heat sink to remove heat from the electric motor.

### CROSS-REFERENCE TO RELATED APPLICATIONS

This application claims the benefit of U.S. Application No. 63/573,059 filed Apr. 2, 2024, the contents of which are incorporated by reference herein in its entirety.

### BACKGROUND

Embodiments of the disclosure relate to environmental control systems, and more specifically to an environmental control system of an aircraft.

In general, contemporary air condition systems are supplied a pressure at cruise that is approximately 30 psig to 35 psig. The trend in the aerospace industry today is towards systems with higher efficiency. One approach to improve airplane efficiency is to eliminate the bleed air entirely and use electrical power to compress outside air. A second approach is to use lower engine pressure. The third approach is to use the energy in the bleed air to compress outside air and bring it into the cabin. Unfortunately, each of these approaches provides limited efficiency with respect to engine fuel burn.

### SUMMARY

According to an embodiment, an environmental control system of a vehicle includes a first inlet for receiving a first medium, a second inlet for receiving a second medium, and at least one thermodynamic device fluidly coupled to the first inlet and the second inlet. The at least one thermodynamic device includes a compressor, at least one turbine, and an electric motor, operably coupled by a shaft. The second inlet is fluidly connected to the electric motor such that a flow of the second medium is operable as a heat sink to remove heat from the electric motor.

In addition to one or more of the features described above, or as an alternative to any of the foregoing embodiments a ram air circuit has at least one ram heat exchanger and the electric motor is fluidly connected to the ram air circuit.

In addition to one or more of the features described above, or as an alternative to any of the foregoing embodiments the second medium from the electric motor is exhausted in to the ram air circuit at a location downstream from the at least one ram heat exchanger.

In addition to one or more of the features described above, or as an alternative to any of the foregoing embodiments the ram air circuit includes a fan operably coupled to another electric motor and the another electric motor is fluidly coupled to the second inlet.

In addition to one or more of the features described above, or as an alternative to any of the foregoing embodiments the electric motor and the another electric motor are arranged in series relative to the flow of the second medium.

In addition to one or more of the features described above, or as an alternative to any of the foregoing embodiments the electric motor and the another electric motor are arranged in parallel relative to the flow of the second medium.

In addition to one or more of the features described above, or as an alternative to any of the foregoing embodiments the at least one thermodynamic device includes a first thermodynamic device and a second thermodynamic device. The first thermodynamic device and the second thermodynamic device are arranged in parallel relative to a flow of the first medium.

In addition to one or more of the features described above, or as an alternative to any of the foregoing embodiments the first thermodynamic device includes the compressor, the at least one turbine, and the electric motor operably coupled by the shaft and the second thermodynamic device includes another compressor, another at least one turbine, and another electric motor, operably coupled by the another shaft.

In addition to one or more of the features described above, or as an alternative to any of the foregoing embodiments the second inlet is fluidly connected to the another electric motor.

In addition to one or more of the features described above, or as an alternative to any of the foregoing embodiments the first thermodynamic device and the second thermodynamic device are arranged in series relative to the flow of the second medium.

In addition to one or more of the features described above, or as an alternative to any of the foregoing embodiments the first thermodynamic device and the second thermodynamic device are arranged in parallel relative to the flow of the second medium.

In addition to one or more of the features described above, or as an alternative to any of the foregoing embodiments a high-pressure water separator is arranged upstream from the at least one turbine relative to a flow of the first medium.

In addition to one or more of the features described above, or as an alternative to any of the foregoing embodiments a mid-pressure water separator is arranged downstream from the at least one turbine relative to a flow of the first medium.

In addition to one or more of the features described above, or as an alternative to any of the foregoing embodiments the first medium is fresh air and the second medium is cabin air.

According to an embodiment, a method of operating an environmental control system of a vehicle includes providing a first portion of a first medium to a first component of a first thermodynamic device and a second portion of the first medium to a first component of a second thermodynamic device in parallel, mixing the first portion of the first medium provided at an outlet of the first component of the first thermodynamic device and the second portion of the first medium provided at an outlet of the first component of the second thermodynamic device to form a flow of the first medium, providing another first portion of the first medium to a second component of the first thermodynamic device and another second portion of the first medium to a second component of the second thermodynamic device in parallel, and mixing the another first portion of the first medium provided at an outlet of the second component of the first thermodynamic device and the another second portion of the first medium provided at an outlet of the second component of the second thermodynamic device to form the flow of the first medium.

In addition to one or more of the features described above, or as an alternative to any of the foregoing embodiments the first component of the first thermodynamic device is a compressor and the first component of the second thermodynamic device is another compressor.

In addition to one or more of the features described above, or as an alternative to any of the foregoing embodiments the first component of the first thermodynamic device is a turbine and the first component of the second thermodynamic device is another turbine.

In addition to one or more of the features described above, or as an alternative to any of the foregoing embodiments removing moisture from the first medium at a location upstream from the second component of the first thermodynamic device and the second component of the second thermodynamic device.

In addition to one or more of the features described above, or as an alternative to any of the foregoing embodiments removing moisture from the first medium at a location downstream from the second component of the first thermodynamic device and the second component of the second thermodynamic device.

In addition to one or more of the features described above, or as an alternative to any of the foregoing embodiments cooling a third component of the first thermodynamic device and a third component of the second thermodynamic device via a second medium.

### BRIEF DESCRIPTION OF THE DRAWINGS

The subject matter is particularly pointed out and distinctly claimed in the claims at the conclusion of the specification. The forgoing and other features, and advantages thereof are apparent from the following detailed description taken in conjunction with the accompanying drawings in which:

FIG. 1 is a schematic diagram of an electrically driven environmental control system according to an embodiment;

FIG. 2 is a schematic diagram of an electrically driven environmental control system according to another embodiment;

FIG. 3 is a schematic diagram of an electrically driven environmental control system according to yet another embodiment;

FIG. 4 is a schematic diagram of an electrically driven environmental control system according to an embodiment; and

FIG. 5 is a schematic diagram of an electrically driven environmental control system according to an embodiment.

### DETAILED DESCRIPTION

A detailed description of one or more embodiments of the disclosed apparatus and method are presented herein by way of exemplification and not limitation with reference to the FIGS.

Embodiments herein provide an environmental control system of an aircraft that receives multiple mediums from different sources and uses energy from one or more of the mediums to operate the environmental control system and to provide cabin pressurization and cooling at a high fuel burn efficiency. The mediums described herein are generally types of air; however, it should be understood that other mediums, such as gases, liquids, fluidized solids, or slurries are also contemplated herein.

With reference now to the FIGS., various examples of a schematic diagram of a portion of an environmental control system (ECS) 20, such as an air conditioning unit or pack for example, are depicted according to a non-limiting embodiment. Although the environmental control system or ECS pack 20 is described with reference to an aircraft, alternative applications, such as another vehicle for example, are also within the scope of the disclosure.

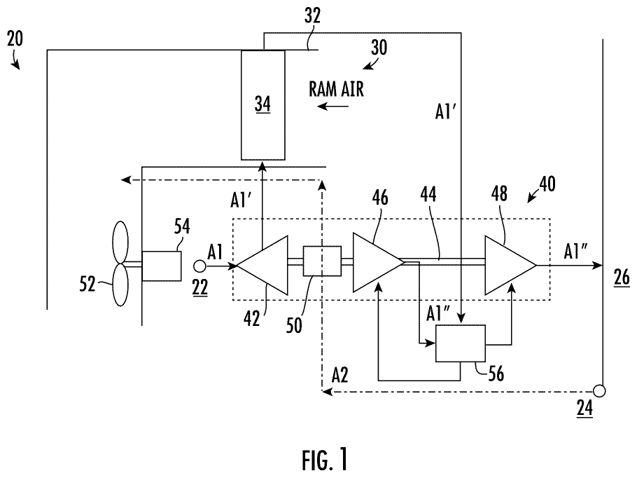

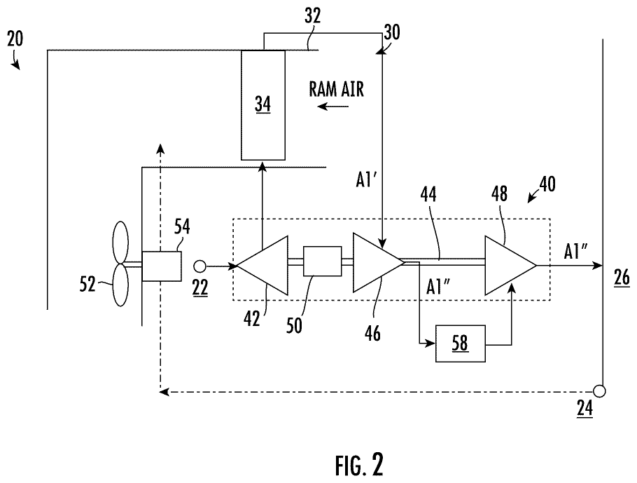

With reference to FIGS. 1 and 2, the ECS 20 may be configured to receive the first medium A1 at a first inlet 22 and may provide a conditioned form of the first medium A1 to a volume 26 during normal operation. In embodiments where the ECS 20 is used in an aircraft application, the first medium A1 may be fresh air, such as outside air for example. The outside air can be procured via one or more scooping mechanisms, such as an impact scoop or a flush scoop for example. Thus, the inlet 22 can be considered a fresh or outside air inlet. In an embodiment, the first medium A1 is ram air drawn from a portion of a ram air circuit. Generally, the first medium A1 described herein may be at an ambient pressure equal to an air pressure outside of the aircraft when the aircraft is on the ground and is between an ambient pressure and a cabin pressure when the aircraft is in flight.

The ECS 20 may alternatively or additionally be configured to receive a second medium A2 at a second inlet 24. In an embodiment, the second inlet 24 is operably coupled to a volume 26, such as the cabin of an aircraft, and the second medium A2 is cabin discharge air, which is air leaving the volume and that would typically be discharged overboard. In some embodiments, the ECS 20 may be configured to extract work from the second medium A2. In this manner, the pressurized air A2 of the volume 26 can be utilized by the ECS 20 to achieve certain operations. However, it should be understood that embodiments where another medium is used as either the first and/or second medium, are also within the scope of the disclosure.

The air conditioning pack of the ECS 20 includes a RAM air circuit 30 including a shell or duct, illustrated schematically at 32, within which one or more heat exchangers are located. The shell 32 can receive and direct a medium, such as ram air for example, through a portion of the ECS 20. The one or more heat exchangers are devices built for efficient heat transfer from one medium to another. Examples of the type of heat exchangers that may be used, include, but are not limited to, double pipe, shell and tube, plate, plate and shell, adiabatic shell, plate fin, pillow plate, and fluid heat exchangers.

The one or more heat exchangers arranged within the shell 32 may be referred to as ram heat exchangers. In the illustrated, non-limiting embodiment, the ram air circuit 30 includes a single ram heat exchanger 34. However, embodiments having two or more heat exchangers are also contemplated herein. Further in embodiments including a plurality of ram air heat exchangers, the plurality of ram air heat exchangers may be arranged in series or in parallel relative to a flow through the ram air circuit 30. Within the heat exchanger 34, ram air, such as outside air for example, acts as a heat sink to cool a medium passing there through, for example the first medium A1.

The ECS 20 additionally includes at least one thermodynamic device 40. A thermodynamic device 40 is a mechanical device that includes components for performing thermodynamic work on a medium (e.g., extracts work from or applies work to the first medium A1, by raising and/or lowering pressure and by raising and/or lowering temperature). Examples of a thermodynamic device include an air cycle machine, a two-wheel air cycle machine, a three-wheel air cycle machine, a four-wheel air cycle machine, etc.

The thermodynamic device 40 may include a plurality of components or wheel, such as a compressor 42 and at least one turbine operably coupled thereto by a shaft 44. In the non-limiting embodiments shown in FIGS. 1 and 2, the thermodynamic device 40 includes two turbines 46 and 48. In such embodiments, a medium, such as the first medium A1 for example, may be configured to flow through one or more the plurality of turbines 46, 48 based on a mode of operation. In some embodiments, the compressor 42 of the thermodynamic device 40 may be considered a first component or wheel, the first turbine 46 may be considered a second component or wheel, and the second turbine 48 may be considered a third component or wheel.

The compressor 42 is a mechanical device configured to raise a pressure of a medium and can be driven by another mechanical device (e.g., a motor or a medium via a turbine). Examples of compressor types include centrifugal, diagonal or mixed-flow, axial-flow, reciprocating, ionic liquid piston, rotary screw, rotary vane, scroll, diaphragm, air bubble, etc. A turbine, such as turbines 46 and 48 for example, is a mechanical device that expands a medium and extracts work therefrom (also referred to as extracting energy). This extracted energy is transmitted to the shaft of the turbine and the other components operably coupled thereto, such as a compressor 42 for example.

In an embodiment, the thermodynamic device 40 has a motor 50 operably coupled thereto. In the illustrated, non-limiting embodiment, the thermodynamic device 40 includes a motor 50 operably coupled to the compressor 42 and the turbines 46, 48 via the rotatable shaft 44. The motor is operable to supplement the energy provided by the first turbine 46 and/or second turbine 48 to drive the compressor 42.

In an embodiment, the ECS 20 includes a fan 52. A fan 52 is a mechanical device that can force via push or pull methods air through the shell of the ram air duct, across at least a portion of the ram air heat exchangers. In an embodiment, such as shown in FIGS. 1 and 2, the fan 52 is a component separate from the thermodynamic device 40 and is driven by any suitable means, such as a motor 54 for example. However, in other embodiments, the fan 52 may be operably coupled to the thermodynamic device 40. For example, the fan 52 may be coupled to the shaft 44 of the thermodynamic device 40. Integration of the fan 52 into the thermodynamic device 40 eliminates the weight of the electric motor 54 and the motor controller (not shown) needed to drive the electric ram fan 52.

The elements of the ECS 20 are connected via valves, tubes, pipes, and the like. Valves (e.g., flow regulation device or mass flow valve) are devices that regulate, direct, and/or control a flow of a medium by opening, closing, or partially obstructing various passageways within the tubes, pipes, etc. of the system. Valves can be operated by actuators, such that flow rates of the medium in any portion of the system can be regulated to a desired value.

During operation of the ECS 20 of FIG. 1, a flow of first medium A1 is received at the first inlet 22. From the first inlet 22, the first medium A1 is provided to the compressor 42 of the thermodynamic device 40. The act of compressing the first medium A1 within the compressor pressurizes and heats it. The resulting compressed first medium A1′ output from the compressor 42 is then provided to the heat exchanger 34 of the ram air circuit 30. A flow of ram air, moving through the ram air duct 32 by the fan 52, is provided to the heat exchanger 34 to cool the compressed first medium A1′.

In the non-limiting embodiment of FIG. 1, the ECS 20 includes a high-pressure water separator 56 arranged downstream from the heat exchanger 34 and upstream from the plurality of turbines 46, 48 of the thermodynamic device 40. The high-pressure water separator 56 may include a condensing heat exchanger and a water extractor arranged in series. In such embodiments, within the heat exchanger 34, the compressed first medium A1′ is cooled to a nearly ambient temperature. This cool compressed first medium A1′ then enters the condensing heat exchanger, where it is cooled by a flow of expanded first medium A1″ output from at least one of the first turbines 46a, 46b. As the compressed first medium A1′ is cooled within the condensing heat exchanger, moisture is condensed from the compressed first medium A1′. The compressed first medium A1′ then enters a water extractor where any free moisture in the compressed first medium A1′ is removed. This cool, dry, compressed first medium A1′ output from the high-pressure water separator 56 is then delivered to an inlet of the first turbine 46. With the first turbine 46, the compressed first medium A1′ is expanded and work is extracted therefrom to form an expanded first medium A1″. The act of extracting work from the compressed first medium A1′ within the turbine 46 cools the compressed first medium A1′. Further, the extracted energy may be used to drive the compressor 42 operably coupled thereto via the shaft 44.

The expanded first portion A1″ output from the first turbine 46 may be provided to a second pass of the condensing heat exchanger of the high-pressure water separator 56. Within the condensing heat exchanger, the expanded first medium A1″ absorbs heat from the compressed first medium A1′ therein. From the condensing heat exchanger, the expanded first medium A1″ is provided to an inlet of the second turbine 48. With the second turbine 48, the expanded first medium A1″ is further expanded and work is extracted therefrom. The further work extracted from the expanded first medium A1″ within the second turbine 48 cools the expanded first medium A1″. Further, the extracted energy may be used to drive the compressor 42. The further expanded medium A1″ output from the second turbine 48 may then be provided to one or more downstream loads, such as the cabin 26 for example.

At the same time, a flow of the second medium A2 may be provided to the ECS 20 via the second inlet 24. As shown, the second medium A2 is used to remove heat from a motor 50 of the thermodynamic device 40 before being exhausted overboard or into the ram air circuit 30, such as at a location downstream from the heat exchanger 34. Alternatively, or in addition, the second medium, A2 may be used to remove heat from the motor 54 of the fan 52. In the illustrated, non-limiting embodiment, the second medium A2 is configured to cool both the motor 50 of the thermodynamic device 40 and the motor 54 associated with the fan 52 in series before being exhausted overboard or into the ram air circuit 30.

The non-limiting embodiment of an ECS 20 illustrated in FIG. 2 is similar to that of FIG. 1. However, the ECS 20 of FIG. 2 includes a mid-pressure water separator 58 in place of the high-pressure water separator 56. During operation of the ECS of FIG. 2, a flow of first medium A1 is received at the first inlet 22 and is provided to the compressor 42 of the thermodynamic device 40. The act of compressing the first medium A1 within the compressor 42 heats it. The resulting compressed first medium A1′ output from the compressors 42 is then provided to the heat exchanger 34 of the ram air circuit 30. A flow of ram air, moving through the ram air duct 32 driven by the fan 52, is provided to the heat exchanger 34 to cool the compressed first medium A1′ therein. In an embodiment, the compressed first medium A1′ is cooled within the heat exchanger 34 to approximately ambient temperature.

In the non-limiting embodiment of FIG. 2, the compressed first medium A1′ output from the heat exchanger 34 is then delivered to the first turbine 46. Within the first turbine 46, the compressed first medium A1′ is expanded and work is extracted therefrom to form an expanded first medium A1″. The act of extracting work from the compressed first medium A1′ within the turbine 46 cools the compressed first medium A1′. Further, the extracted energy may be used to drive the compressor 42 operably coupled thereto.

During its expansion within the first turbine 46, the compressed first medium A1′ is further cooled such that moisture within the compressed first medium A1′ is condensed. The temperature of the expanded first medium A1″ at the outlet of the first turbine 46 may have a temperature close to freezing. The expanded first medium A1″ provided at the outlet of the first turbine 46 is then sent to a water extractor 58, where any free moisture in the expanded first medium A1″ is removed. The first turbine 46 in combination with the water extractor 58 may be considered a mid-pressure water separator.

The resulting dry expanded first medium A1″ may then be provided to the second turbine 48 where it is further expanded and more work is extracted therefrom. Accordingly, the first medium A1 may be provided to the first turbine 46 and the second turbine 48 in series. Work extracted from the expanded first medium A1″ within the second turbine 48 may also be used to drive the compressor 42 via the shaft 44. The further expanded medium A1″ output from the second turbine 48 may then be provided to one or more downstream loads, such as the cabin 26 for example.

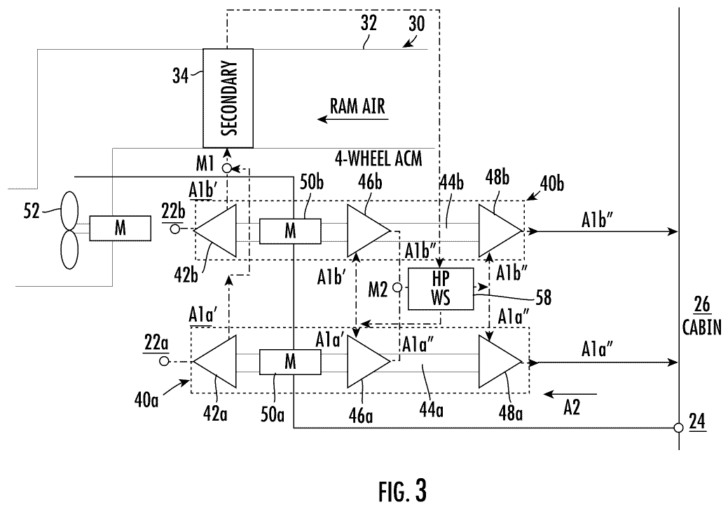

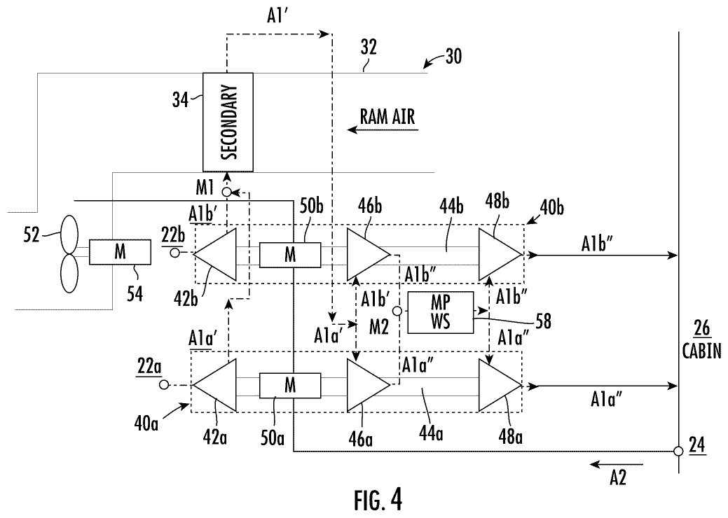

The environmental control systems 20 illustrated in FIGS. 3 and 4 are similar to those shown in FIGS. 1 and 2, respectively. However, the embodiments of an ECS 20 illustrated in FIGS. 1 and 2 include a single thermodynamic device 40, whereas the embodiments shown in FIGS. 3 and 4 include a plurality of thermodynamic devices, such as a first thermodynamic device 40a and a second thermodynamic device 40b for example. The first and second thermodynamic devices 40a, 40b may have similar configurations, or alternatively, may have different configurations. In the illustrated, non-limiting embodiment, the first thermodynamic device 40a includes a compressor 42a, a first turbine 46a, a second turbine 48a, and an electric motor 50a operably coupled via a shaft 44a, and the second thermodynamic device 40b includes another compressor 42b, another first turbine 46b, another second turbine 48b, and another electric motor 50b operably coupled via another shaft 44b. In an embodiment, the first and second thermodynamic device 40a, 40b may be arranged in parallel relative to a flow of one or more mediums through the ECS 20.

In embodiments including two thermodynamic devices 40a, 40b, the system may include two inlets 22a, 22b for receiving the first medium A1 such that a respective flow of first medium A1 is provided to each thermodynamic device. Alternatively, the ECS 20 may include a single first inlet 22, and the flow at the first inlet may be divided between the compressors 42a, 42b. In either configuration, a first portion or flow of first medium A1a is provided to an inlet of the compressor 42a and a second portion or flow of first medium A1b is provided to the inlet of the another compressor 42b.

With reference to the ECS 20 of FIG. 3, the act of compressing a respective portion or flow A1a, A1b of first medium within each compressor 42a, 42b pressurizes and heats it. The resulting compressed first medium A1a′ and A1b′ output from the compressors 42a, 42b, respectively, is then mixed at a location directly downstream from the outlet of the compressors 42a, 42b, identified at M1. The compressed first medium A1′ formed by combining the compressed first portion A1a′ and the compressed second portion A1b′ is then provided to the heat exchanger 34 of the ram air circuit 30. A flow of ram air, moving through the ram air duct 32, such as driven by the fan 52 for example, is provided to the heat exchanger 34 to cool the compressed first medium A1′.

Similar to the embodiment of FIG. 1, the ECS 20 of FIG. 3 includes a high-pressure water separator 56 arranged downstream from the heat exchanger 34 and upstream from the plurality of first turbines 46a, 46b of the thermodynamic devices 40a, 40b. In an embodiment, the high-pressure water separator 56 is arranged directly downstream from the heat exchanger 34 and/or directly upstream from the plurality of first turbines 46a, 46b. The high-pressure water separator 56 may include a condensing heat exchanger and a water extractor arranged in series. In such embodiments, within the heat exchanger 34, the compressed first medium A1′ is cooled to a nearly ambient temperature. This cool compressed first medium A1′ then enters the condensing heat exchanger, where it is cooled by a flow of expanded first medium A1″ output from at least one of the first turbines 46a, 46b. As the compressed first medium A1′ is cooled within the condensing heat exchanger, moisture is condensed from the compressed first medium A1′. The compressed first medium A1′ then enters a water extractor where any free moisture in the compressed first medium A1′ is removed.

This cool dry compressed first medium A1′ output from the high-pressure water separator 56 is then delivered to at least one of the first turbine 46a and the another first turbine 46b. In an embodiment, the compressed first medium A1′ output from the high-pressure water separator 56 is provided to the first turbines 46a, 46b of both thermodynamic devices 40a, 40b in parallel. As shown, a first portion A1a′ of the compressed first medium is delivered to the inlet of the first turbine 46a of the first thermodynamic device 40a and a second portion A1b′ of the compressed medium is delivered to the inlet of the first turbine 46b of the second thermodynamic device 40b. Within the first turbines 46a, 46b, the first portion A1a′ and the second portion A1b′ of compressed first medium A1′, respectively, is expanded and work is extracted therefrom. The act of extracting work from the first portion A1a′ and the second portion A1b′ of the compressed first medium A1′ within the first turbines 46a, 46b cools the compressed first medium A1′. Further, the extracted energy may be used to drive a respective compressor 42a, 42b operably coupled thereto.

The expanded first portion A1a″ and the expanded second portion A1b″ output from the first turbines 46a, 46b may then be mixed at a location directly downstream from the outlet of the turbines 46a, 46b, identified at M2. The expanded first medium A1″ formed by combining the expanded first portion A1a″ and the expanded second portion A1b″ flows through a second pass of the condensing heat exchanger. Within the condensing heat exchanger, the expanded first medium A1″ absorbs heat from the compressed first medium A1′ therein.

From the condensing heat exchanger, the expanded first medium A1″ is provided to at least one of the second turbines 48a, 48b of the first and second thermodynamic devices 40a, 40b. In an embodiment, the expanded first medium A1″ output from the high-pressure water separator 56 is provided to second turbines 48a, 48b of both thermodynamic devices 40a, 40b in parallel. As shown, a first portion A1a″ of the expanded first medium is delivered to the inlet of the second turbine 48a and a second portion A1b″ of the expanded first medium is delivered to the inlet of second turbine 48b.

Within the second turbines 48a, 48b, the expanded first portion A1a″ and the expanded second portion A1b″ of the expanded first medium A1″ is further expanded and work is extracted therefrom. The further work extracted from the expanded first portion A1a″ and the expanded second portion A1b″ within the second turbines 48a, 48b cools the portions A1a “, A1b” of expanded first medium. Further, the extracted energy may be used to drive a respective compressor 42a, 42b operably coupled thereto. The further expanded medium A1″ output from one or both second turbines 48a, 48b may then be provided to one or more downstream loads, such as the cabin 26 for example. The expanded first portion A1a″ and the expanded second portion A1b″ of the first medium output from each second turbine 48a, 48b may be provided to a respective outlet, as shown, or alternatively, the expanded first and second portions A1a″ and A1b″ of the expanded first medium A1 may be rejoined before being delivered to an outlet.

At the same time, a flow of the second medium A2 may be provided to the ECS 20 via the second inlet 24. As shown, the second medium A2 is used to remove heat from a motor of at least one thermodynamic device 40a, 40b being exhausted overboard or into the ram air circuit 30 downstream from the heat exchanger 34. In the illustrated, non-limiting embodiment, the second medium A2 is configured to cool both the motor 50a and the motor 50b in series before being exhausted overboard or into the ram air circuit 30. However, in other embodiments, the second medium A2 may be configured to cool the motors 50a, 50b in parallel. Further, the flow path of the second medium A2 may be configured to cool the motor 54 of the fan 52 in series with at least one of the motors 50a, 50b.

The non-limiting embodiment of an ECS 20 shown in FIG. 4 is similar to that of FIG. 3. However, the ECS 20 of FIG. 2 includes a mid-pressure water separator in place of the high-pressure water separator. During operation of the ECS of FIG. 4, a portion or flow of first medium A1a is provided to the inlet of the of the compressor 42a and a second portion or flow of first medium A1b is provided to the inlet of the another compressor 42b. The act of compressing a respective portion or flow A1a, A1b of first medium within each compressor 42a, 42b pressurizes and heats it. The resulting compressed first medium A1a′ and A1b′ output from the compressors 42a, 42b, respectively, is then mixed at a location directly downstream from the outlet of the compressors 42a, 42b, identified at M1. The compressed first medium A1′ formed by combining the compressed first portion A1a′ and the compressed second portion A1b′ is then provided to the heat exchanger 34 of the ram air circuit 30. A flow of ram air, moving through the ram air duct 32, such as driven by the fan 52 for example, is provided to the heat exchanger 34 to cool the compressed first medium A1′. In an embodiment, the compressed first medium A1′ is cooled within the heat exchanger 34 to approximately ambient temperature.

The heat exchanger 34 is fluidly connected to at least one of the first turbine 46a and the another first turbine 46b such that the compressed first medium A1′ is delivered thereto. In an embodiment, the compressed first medium A1′ output from the heat exchanger 34 is provided to the first turbines 46a, 46b of both thermodynamic devices 40a, 40b in parallel. As shown, a first portion A1a′ of the compressed first medium is delivered to the inlet of the first turbine 46a of the first thermodynamic device 40a and a second portion A1b′ of the compressed medium is delivered to the inlet of the first turbine 46b of the second thermodynamic device 40b. Within the first turbines 46a, 46b, the first portion A1a′ and the second portion A1b′ of compressed first medium A1′, respectively, is expanded and work is extracted therefrom. The act of extracting work from the first portion A1a′ and the second portion A1b′ of the compressed first medium A1′ within the first turbines 46a, 46b cools the compressed first medium A1′. Further, the extracted energy may be used to drive a respective compressor 42a, 42b operably coupled thereto.

During its expansion within the first turbines 46a, 46b, the first and/or second portions A1a′, A1b′ of compressed first medium are further cooled and moisture within the portions A1a′, A1b′ of compressed first medium is condensed. In an embodiment, the first portion A1a″ of the expanded first medium at the outlet of the first turbine 46a and/or the second portion A1b″ of the expanded first medium A1 at the outlet of the first turbine 46b has a temperature close to freezing.

The expanded first portion A1a″ and the expanded second portion A1b″ output from the first turbines 46a, 46b may then be mixed at a location directly downstream from the outlet of the turbines 46a, 46b, identified at M2, to form an expanded first medium A1″. The expanded first medium A1″ may be sent to a water extractor 58, where any free moisture in the expanded first medium A1″ is removed. Each first turbine 46a, 46b in combination with the water extractor 58 may be considered a mid-pressure water separator.

The resulting dry expanded first medium A1″ output from the water extractor 58 may then be provided to at least one second turbine 48a, 48b of a thermodynamic device 40a, 40b. In the illustrated, non-limiting embodiment, the expanded first medium A1″ is provided to the second turbines 48a, 48b of both thermodynamic devices 40a, 40b in parallel. As shown, a first portion A1a″ of the expanded first medium is delivered to the inlet of the second turbine 48a and a second portion A1b″ of the expanded first medium is delivered to the inlet of second turbine 48b. Within the second turbines 48a, 48b, the expanded first portion A1a″ and the expanded second portion A1b″ of the expanded first medium is further expanded and work is extracted therefrom. The further work extracted from the expanded first portion A1a″ and the expanded second portion A1b″ within the second turbines 48a, 48b cools the portions A1a″, A1b″ of expanded first medium. Further, the extracted energy may be used to drive a respective compressor 42a, 42b operably coupled thereto. The further expanded medium A1″ output from one or both second turbines 48a, 48b may then be provided to one or more downstream loads, such as the cabin 26 for example. The expanded first portion A1a″ and the expanded second portion A1b″ of the first medium output from each second turbine 48a, 48b may be provided to a respective outlet, as shown, or alternatively, the expanded first and second portions A1a″ and A1b″ of the expanded first medium A1 may be rejoined before being delivered to an outlet.

At the same time, a flow of the second medium A2 may be provided to the ECS 20 via the second inlet 24. As shown, the second medium A2 is used to remove heat from a motor of at least one thermodynamic device 40a, 40b being exhausted overboard or into the ram air circuit 30 downstream from the heat exchanger 34. In the illustrated, non-limiting embodiment, the second medium A2 is configured to cool both the motor 50a and the motor 50b in series before being exhausted overboard or into the ram air circuit 30. However, in other embodiments, the second medium A2 may be configured to cool the motors 50a, 50b in parallel. Further, the flow path of the second medium A2 may be configured to cool the motor 54 of the fan 52 in series with at least one of the motors 50a, 50b.

In each of the embodiments of FIGS. 3 and 4, the flow of the first medium is divided directly upstream from each corresponding component of a thermodynamic device 40a, 40b into multiple flows, and the multiple flows of the first medium are rejoined directly downstream from each component of the thermodynamic devices 40a, 40b. For example, separate flows of first medium A1 are provided to the compressors 42a, 42b, but are rejoined directly downstream therefrom. The compressed first medium A1′ is separated into multiple flows directly upstream from the first turbines 46a, 46b of the thermodynamic devices 40a, 40b, but are rejoined directly downstream from an outlet of the first turbines 46a, 46b. Similarly, the expanded first medium A1″ is split into multiple flow directly upstream from the second turbines 48a, 48b of the thermodynamic devices 40a, 40b, and may be rejoined downstream from an outlet thereof.

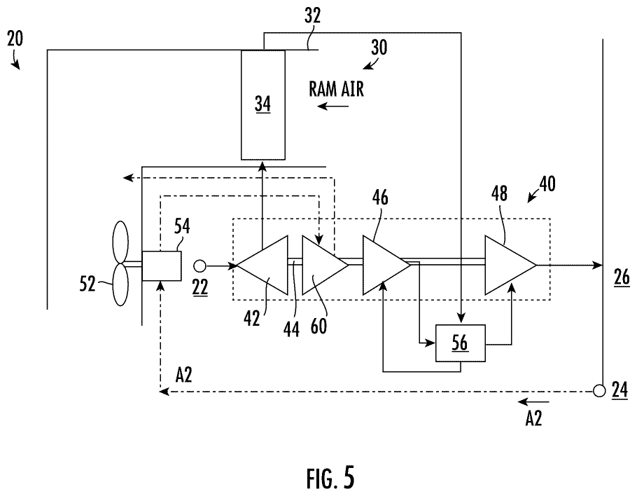

Yet another embodiment of an ECS 20 is illustrated in FIG. 5. The ECS of FIG. 5 is similar to that of FIG. 1; however, the thermodynamic device includes an additional power turbine 60 mounted to the shaft 44 in place of the motor 50. The first medium A1 will flow through the system as described above with respect to FIG. 1. The flow of the second medium A2 provided to the ECS 20 via the second inlet 24 is used to remove heat from the motor 54 of the fan 52 associated with the ram air circuit 30. The second medium A2 acts as a heat sink and absorbs heat from the motor 54. The heated second medium A2 may then be provided to an inlet of the power turbine 60.

With the power turbine 60, the second medium A2 is expanded and work is extracted therefrom to form an expanded second medium A2″. The act of extracting work from the second medium A2 within the turbine 60 cools the second medium A2. Further, the extracted energy may be used to drive the compressor 42 operably coupled thereto via the shaft 44. The expanded second medium A2″ provided at an outlet of the power turbine 60 may then be exhausted overboard or may be dumped into the ram air circuit 30, such as at a location downstream from the at least one ram heat exchanger 34. Although the system of FIG. 5 is illustrated as having a high-pressure water separator, it should be understood that an ECS 20 having a mid-pressure water separator as shown in FIG. 2, may have a thermodynamic device 40 adapted to include a power turbine in place of the motor 50.

An ECS 20 as described herein with respect to FIGS. 1-4 does not require an air supply system located upstream from the air conditioning pack. Rather, the first medium provided at the inlet 22, 22a, 22b may be generally the same temperature and/or pressure as the ambient air outside of the aircraft. However, in the embodiment illustrated in FIG. 5, the first medium provided to the inlet 22, 22a, 22b is output from an upstream electric air compressor or a bleed air system.

An ECS 20 including a mid-pressure water separator as shown in FIGS. 2 and 4 is beneficial in that the weight of the condensing heat exchanger and the corresponding ducts associated with the high-pressure water separator are eliminated. Further, it eliminates the parasitic losses and pressure drop associated with those components. The end result is an ECS 20 that is lighter in weight and uses less energy to cool the cabin. Further, the ECS 20 disclosed herein is advantageous in that it eliminates a conventional primary heat exchanger of the ram air circuit 30.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An environmental control system of a vehicle, the environmental control system comprising:
a first inlet for receiving a first medium;
a second inlet for receiving a second medium;
at least one thermodynamic device fluidly coupled to the first inlet and the second inlet, the at least one thermodynamic device including a compressor, at least one turbine, an electric motor, and a shaft, the compressor, the at least one turbine and the electric motor being operably coupled by the shaft; and
wherein the second inlet is fluidly connected to the electric motor such that a flow of the second medium is operable as a heat sink to remove heat from the electric motor.

2. The environmental control system of claim 1, further comprising a ram air circuit having at least one ram heat exchanger, wherein the electric motor is fluidly connected to the ram air circuit.

3. The environmental control system of claim 2, wherein the second medium from the electric motor is exhausted in to the ram air circuit at a location downstream from the at least one ram heat exchanger.

4. The environmental control system of claim 2, wherein the ram air circuit further comprises a fan operably coupled to another electric motor, wherein the another electric motor is fluidly coupled to the second inlet.

5. The environmental control system of claim 4, wherein the electric motor and the another electric motor are arranged in series relative to the flow of the second medium.

6. The environmental control system of claim 4, wherein the electric motor and the another electric motor are arranged in parallel relative to the flow of the second medium.

7. The environmental control system of claim 1, wherein the at least one thermodynamic device further comprises a first thermodynamic device and a second thermodynamic device, the first thermodynamic device and the second thermodynamic device being arranged in parallel relative to a flow of the first medium.

8. The environmental control system of claim 7, wherein the first thermodynamic device includes the compressor, the at least one turbine, and the electric motor operably coupled by the shaft and the second thermodynamic device includes another compressor, another at least one turbine, another electric motor, and another shaft, the another compressor, the another at least one turbine and the another electric motor being operably coupled by the another shaft.

9. The environmental control system of claim 8, wherein the second inlet is fluidly connected to the another electric motor.

10. The environmental control system of claim 7, wherein the first thermodynamic device and the second thermodynamic device are arranged in series relative to the flow of the second medium.

11. The environmental control system of claim 7, wherein the first thermodynamic device and the second thermodynamic device are arranged in parallel relative to the flow of the second medium.

12. The environmental control system of claim 1, further comprising a high-pressure water separator arranged upstream from the at least one turbine relative to a flow of the first medium.

13. The environmental control system of claim 1, further comprising a mid-pressure water separator arranged downstream from the at least one turbine relative to a flow of the first medium.

14. The environmental control system of claim 1, wherein the first medium is fresh air and the second medium is cabin air.

15. A method of operating an environmental control system of a vehicle, the method comprising:
providing a first portion of a first medium to a first component of a first thermodynamic device and a second portion of the first medium to a first component of a second thermodynamic device in parallel;
mixing the first portion of the first medium provided at an outlet of the first component of the first thermodynamic device and the second portion of the first medium provided at an outlet of the first component of the second thermodynamic device to form a flow of the first medium;
providing another first portion of the first medium to a second component of the first thermodynamic device and another second portion of the first medium to a second component of the second thermodynamic device in parallel; and
mixing the another first portion of the first medium provided at an outlet of the second component of the first thermodynamic device and the another second portion of the first medium provided at an outlet of the second component of the second thermodynamic device to form the flow of the first medium.

16. The method of claim 15, wherein the first component of the first thermodynamic device is a compressor and the first component of the second thermodynamic device is another compressor.

17. The method of claim 15, wherein the first component of the first thermodynamic device is a turbine and the first component of the second thermodynamic device is another turbine.

18. The method of claim 15, further comprising removing moisture from the first medium at a location upstream from the second component of the first thermodynamic device and the second component of the second thermodynamic device.

19. The method of claim 15, further comprising removing moisture from the first medium at a location downstream from the second component of the first thermodynamic device and the second component of the second thermodynamic device.

20. The method of claim 15, further comprising cooling a third component of the first thermodynamic device and a third component of the second thermodynamic device via a second medium.
